(19) United States
(12) Patent Application Publication
(10) Pub. No.: US 2015/0139634 A1
(43) Pub. Date: May 21, 2015

(54) SYSTEM FOR CORRECTING HAND-SHAKE AND CONTROLLING METHOD THEREOF

(71) Applicant: SAMSUNG ELECTRO-MECHANICS CO., LTD., Gyeonggi-Do (KR)

(72) Inventor: Kyung Uk KIM, Gyeonggi-Do (KR)

(73) Assignee: SAMSUNG ELECTRO-MECHANICS CO., LTD., Gyeonggi-Do (KR)

(21) Appl. No.: 14/267,462

(22) Filed: May 1, 2014

(30) Foreign Application Priority Data
Nov. 21, 2013 (KR) 10-2013-0142342

(51) Int. Cl. H04N 5/232

(52) U.S. Cl. CPC H04N 5/23287
USPC 396/53

(57) ABSTRACT

Embodiments of the invention provide a system for correcting hand-shake, including a position sensor detecting positional information of a lens, a digital signal processor generating a digital control signal for controlling a driving range of the lens based on the detected positional information, and a motor driver generating a driving voltage and a control signal of an actuator for driving the lens based on the digital control signal and controlling the driving of the actuator.

### CROSS REFERENCE TO RELATED APPLICATION

This application claims the benefit of and priority under 35 U.S.C. §119 to Korean Patent Application No. KR 10-2013-0142342, entitled “System For Correcting Hand-Shake And Controlling Method Thereof,” filed on Nov. 21, 2013, which is hereby incorporated by reference in its entirety into this application.

### BACKGROUND

1. Field of the Invention

The present invention to a system for correcting hand-shake and a controlling method thereof.

2. Description of the Related Art

A digital photographing apparatus may perform image processing on an image received through an imaging device using a digital signal processor, compress the image to generate an image file, and store the image file in a memory.

Further, the digital photographing apparatus may display the image of the image file received through the imaging device or stored in a storage medium on a display device such as an LCD. However, when a user photographs a desired image, the digital photographing apparatus such as a camera may shake due to user's hand-shake and thus the image input through the imaging device may shake, such that the photographing may lead to failure.

Therefore, according to the conventional art, for example, Korean Patent Publication No. 10-2010-0104383, to prevent the photographing failure due to the hand-shake, as described in the following Prior Art Document, when the hand-shake occurs, an angular velocity of the camera is detected by a gyro sensor, which is equipped in the camera, a driving distance of a camera lens is calculated based on the detected angular velocity, and then a correction process of the photographed image is performed by a function of correcting hand-shake (optical image stabilization (OIS)) which moves the lens through an actuator as much as the driving distance.

However, when photographer's hand-shake finely occurs or when the signal detected by the gyro sensor is weak and thus a current driving the actuator is finely changed, a direction of the driving current of the actuator is unstably set, such that the accuracy of the lens driving may be reduced.

### SUMMARY

Accordingly, embodiments of the invention provide a system for correcting hand-shake and a controlling method thereof capable of ensuring reliability of image-shake correction due to a user's hand-shake, by setting a brake section in an intermediate region of a driving range of a lens to enable more stable driving when a driving direction of the lens is switched.

According to an embodiment of the invention, there is provided a system for correcting hand-shake, including a position sensor detecting positional information of a lens; a digital signal processor generating a digital control signal for controlling a driving range of the lens based on the detected positional information, and a motor driver generating a driving voltage and a control signal of an actuator for driving the lens based on the digital control signal and controlling the driving of the actuator by a switching operation corresponding to the control signal.

According to an embodiment, the position sensor includes a hall sensor outputting a signal corresponding to a position of the lens, and an angular velocity sensor outputting an angular velocity signal to shaking input from the outside.

According to an embodiment, the driving of the lens includes a brake section in a predetermined region of the driving range of the lens.

According to an embodiment, the brake section is a section in which a driving direction of the lens is switched and is an intermediate region of the driving range.

According to an embodiment, the brake section is a region of 1% to 5% of the driving range of the lens.

According to an embodiment, the control signal controls a driving of the actuator to correspond to the driving direction before and after the lens or whether the brake driving is performed on one axis of the lens.

According to an embodiment, the actuator is a voice coil motor.

According to an embodiment, the digital signal processor generates the control signal by a proportion integral derivative (PID) control.

According to an embodiment, the motor driver includes a signal converter generating the driving voltage of the actuator corresponding to the digital control signal, which is generated by the digital signal processor, a controller generating the control signal of the actuator for driving the lens based on the digital control signal, and a driver circuit applying the driving voltage to the actuator by the switching operation based on the control signal.

According to an embodiment, the driving of the lens includes a brake section in a predetermined region of the driving range of the lens.

According to an embodiment, the brake section is a section in which a driving direction of the lens is switched and is an intermediate region of the driving range.

According to an embodiment, the brake section is a region of 1% to 5% of the driving range of the lens.

According to an embodiment, the control signal controls the driving direction of the lens or whether the brake driving is performed on one axis of the lens.

According to an embodiment, the actuator is a voice coil motor.

According to an embodiment, the driver circuit includes a transistor circuit controlling a driving current of the actuator based on the driving voltage; and a switching circuit controlling a driving of the transistor circuit through the switching operation depending on the control signal.

According to an embodiment, the driver circuit further includes a voltage follower transferring the driving voltage input from the signal converter to one terminal of the transistor circuit.

According to an embodiment, the transistor is a metal oxide semiconductor (MOS) transistor.

According to another embodiment of the invention, there is provided a method for correcting hand-shake, including detecting, by a position sensor, positional information of a lens; generating, by a digital signal processor, a digital control signal for controlling a driving range of the lens based on the detected positional information, and generating, by a motor driver, a driving voltage and a control signal of an actuator for driving the lens based on the digital control signal and controlling the driving of the actuator by a switching operation corresponding to the control signal.

According to an embodiment, the controlling of the driving of the actuator includes generating, by a signal converter, a driving voltage of the actuator corresponding to the digital control signal, generating, by a controller, the control signal of the actuator for driving the lens based on the digital control signal, and applying, by a driver circuit, the driving voltage to the actuator by the switching operation based on the control signal.

According to an embodiment, the applying of the driving voltage to the actuator may include controlling, by a transistor circuit, a driving current of the actuator based on the driving voltage, and controlling, by a switching circuit, a driving of the transistor circuit through the switching operation depending on the control signal.

According to an embodiment, the method for correcting hand-shake further includes transferring, by a voltage follower, the driving voltage input from the signal converter to one terminal of the transistor circuit.

According to an embodiment, the control signal may control a driving of the actuator to correspond to the driving direction of the lens or whether the brake driving is performed on one axis of the lens.

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a block diagram illustrating a system for correcting hand-shake according to an embodiment of the invention.

FIG. 2 is a flow chart illustrating a controlling method of the system for correcting hand-shake according to an embodiment of the invention.

FIG. 3 is a block diagram illustrating a configuration of a motor driver according to an embodiment of the invention.

FIG. 4 is a circuit diagram showing the configuration of the motor driver according to an embodiment of the invention.

FIGS. 5A and 5B are diagrams illustrating a driving of the motor driver according to an embodiment of the invention.

### DETAILED DESCRIPTION

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. Like reference numerals refer to like elements throughout the specification.

Hereinafter, a system for correcting hand-shake and a controlling method thereof according to a preferred embodiment of the present invention will be described in detail with reference to the accompanying drawings, in which a driving of a lens will be described below based on one axis (X axis or Y axis) of the lens, which may also be likewise applied to the other axis (X axis or Y axis).

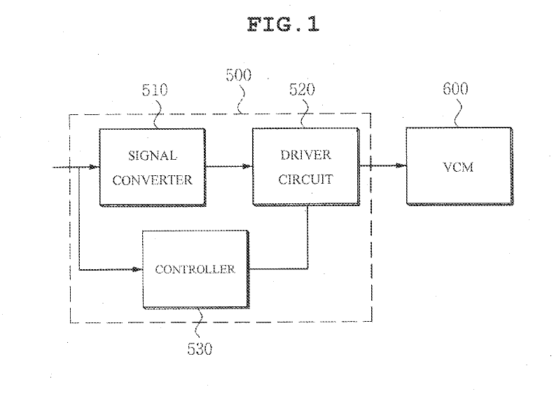

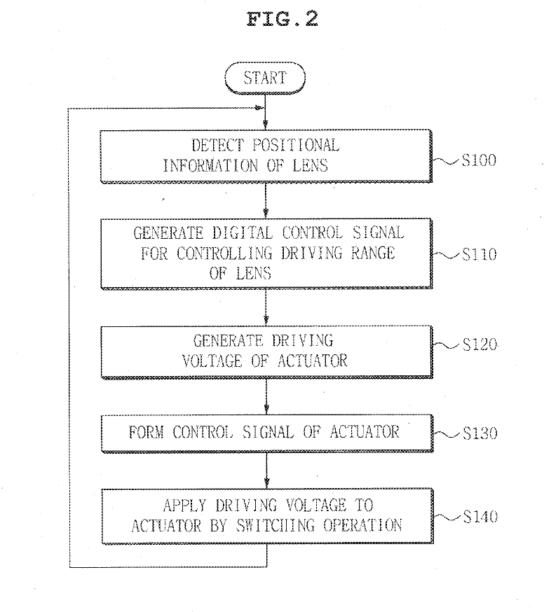

FIG. 1 is a block diagram illustrating a system for correcting hand-shake according to an embodiment of the invention, and FIG. 2 is a flow chart illustrating a controlling method of the system for correcting hand-shake according to an embodiment of the invention, in which the system for correcting hand-shake is a voice coil motor (hereinafter, referred to as VCM).

As illustrated in FIG. 1, a system 10 for correcting hand-shake according to an embodiment of the invention includes a position sensor 100, an amplifier 200, a digital signal processor 400, a signal converter 300, a motor driver 500, an actuator 600, and a lens 700.

According to an embodiment, the position sensor 100 includes a hall sensor (not illustrated) detecting a current position of the lens 700 using a hall effect, which changes a voltage depending on a magnetic field strength, and an angular velocity (gyro) sensor (not illustrated) detecting an angular velocity of a motion due to photographer's hand-shake, in which positional information of the lens 700 may be detected using the hall sensor (not illustrated) and the angular velocity sensor (not illustrated) (S100). Herein, the positional information, according to an embodiment, includes a current position of the lens 700, for example, a moving distance, a rotating angle, or the like, due to hand-shake, in which the lens 700 is configured of a zoom lens ZL, a focus lens FL, or a correction lens CL, but is not limited thereto.

The amplifier 200 amplifies a voltage corresponding to the current position of the lens 700 detected by the hall sensor (not illustrated) and is, for example, a low noise amplifier (LNA) and the signal converter 300 converts the amplified voltage value into a digital value and is, for example, an analog digital converter.

As further shown in FIGS. 1 and 2, the digital signal processor 400, according to an embodiment, generates a digital control signal (serial signal) for controlling a driving range of the lens 700 based on the positional information of the lens 700 detected by the position sensor 100 (S110). Herein, the digital control signal is configured, for example, of 10 bits, in which a most significant bit (MSB) among 10 bits is a sign bit and represents a driving direction of the lens 700 and the remaining bits represents, for example, a magnitude in driving current of the actuator (VCM), which corresponds to the moving distance of the lens 700. Herein, the digital signal processor 400 generates the digital control signal by a proportion integral derivative control (PID) control.

According to an embodiment, the motor driver 500 generates a driving voltage and a control signal of the actuator 600 for driving the lens 700 based on the digital control signal input form the digital signal converter 300 (S120 and S130) and controls the driving of the actuator 600 by a switching operation corresponding to the control signal (S140), in which the driving of the lens 700 includes a brake section in a predetermined region of the driving range of the lens 700 and the brake section is a section in which the driving direction of the lens 700 is switched and is an intermediate region of the driving range. Herein, the actuator 600 is, for example, a voice coil motor and the detailed contents thereof will be described below.

As described above, the system for correcting hand-shake sets the brake section in the intermediate region of the driving range of the lens to be able to more stably perform the image-shake correction due to the photographer's hand-shake based on the positional information detected by the position sensor at the time of driving the lens.

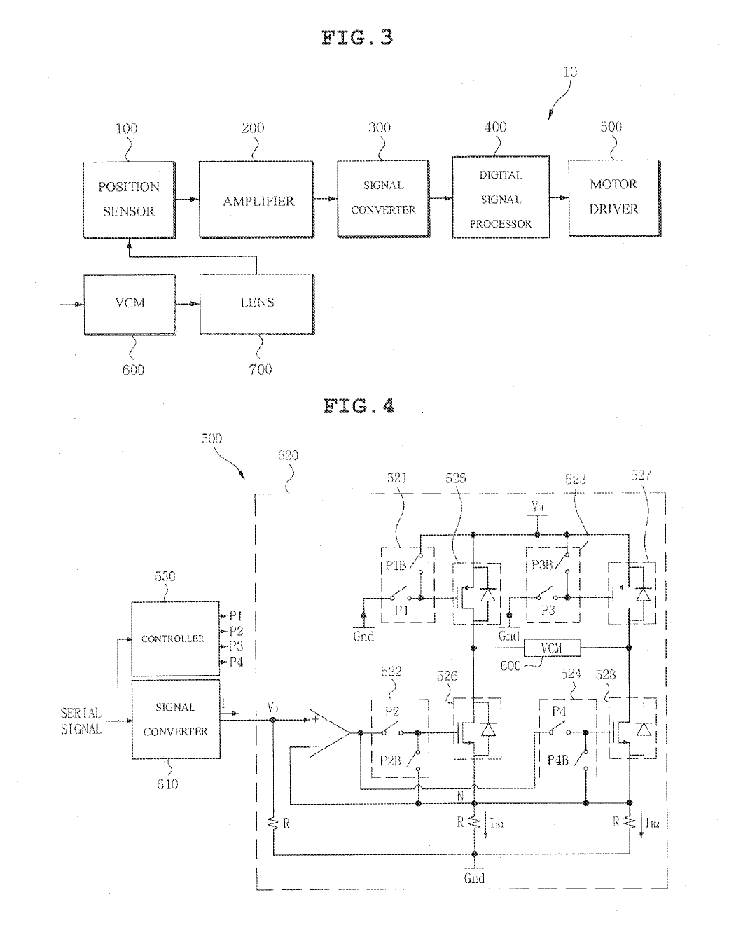

Hereinafter, referring to FIGS. 3 and 4, a process of correcting hand-shake by driving the actuator depending on the digital control signal in the motor driver according to an embodiment of the invention will be described in more detail.

FIG. 3 is a block diagram illustrating a configuration of a motor driver according to an embodiment of the invention, and FIG. 4 is a circuit diagram showing the configuration of the motor driver according to an embodiment of the invention.

As illustrated in FIG. 3, the motor driver 500 generates the driving voltage and the control signal of the actuator 600 for driving the lens 700 based on the digital control signal and controls the driving of the actuator 600 by the switching operation corresponding to the control signal and includes, according to an embodiment, a signal converter 510, a driver circuit 520, and a controller 530. Herein, the actuator 600 is, for example, a voice coil motor and a DC motor, but is not limited thereto.

As illustrated in FIG. 4, the signal converter 510 receives the digital control signal (e.g., serial signal, 10 bits) generated from the digital signal processor 400, generates a driving voltage V_{D} (see FIG. 4) of the actuator 600 corresponding to the digital control signal, in which the driving voltage V_{D} (see FIG. 4) is a voltage which forms a voltage difference from a power supply voltage V_{M} to make a driving current I_{B1} or I_{B2} flow in the actuator (VCM) 600 and the signal converter 510 is, for example, a current DAC, which converts the digital signal to a current.

The controller 530 generates control signals P₁ to P₄ of the actuator 600 for driving the lens 700 based on the digital control signal (e.g., serial signal, 10 bits), in which the driving of the lens 700 includes the brake section in the predetermined region of the driving range of the lens 700 and the brake section is a section in which the driving direction of the lens 700 is switched and is the intermediate region of the driving range, and is, for example, a region of 1% to 5% of the driving range of the lens 700. Herein, the control signal controls the driving direction of the lens 700 or whether the brake driving is performed on one axis of the lens 700 through the control of the driver circuit 520.

The driver circuit 520 applies the driving voltage to the actuator by the switching operation, which is controlled by the control signals P₁ to P₄ applied from the controller 530 and includes, according to an embodiment, a voltage follower 529, transistor circuits 525 to 528 including a plurality of transistors (hereinafter, referred to as TR), and switching circuits 521 to 524 controlling a driving of the transistor circuit.

The voltage follower 529 amplifies the driving voltage V_{D} applied from the signal converter 510 with a preset predetermined gain and may serve as a buffer amplifier (voltage follower) of which the amplification ratio is equal to 1 and transfer the driving voltage V_{D} to one terminal of the transistor circuit 529 and the transistor circuits 525 to 528 include a plurality of transistors (first to fourth TRs), which control the driving current I_{B1} or I_{B2} of the actuator 600 based on the driving voltage V_{D}. Herein, the first to fourth TRs 525 to 528 are, for example, a metal oxide semiconductor (MOS) transistor.

According to an embodiment, the switching circuits 521 to 524 control the driving of the transistor circuits 525 to 528 by the switching operation depending on the control signals P₁ to P₄ applied from the controller 530. Thus, the switching circuits 521 to 524 control the driving of the transistor circuits 525 to 528 by the operation of the switching of the first to fourth switches 521 to 524 each of which are electrically connected to the first to fourth TRs 525 to 528 configuring the transistor circuits 525 to 528. Herein, 1) the first to fourth switches 521 to 524 include at least one switch, which performs a complementary switching operation.

As described above, according to an embodiment of the invention, when the position sensor does not detect the hand-shake, and thus the process of correcting image-shake based on the movement of the lens is not required, the lens is located in the preset brake section using the motor driver to prevent the driving current, which may be generated when the driving direction of the lens is switched, from overshooting, thereby ensuring the stability and accuracy of the entire system.

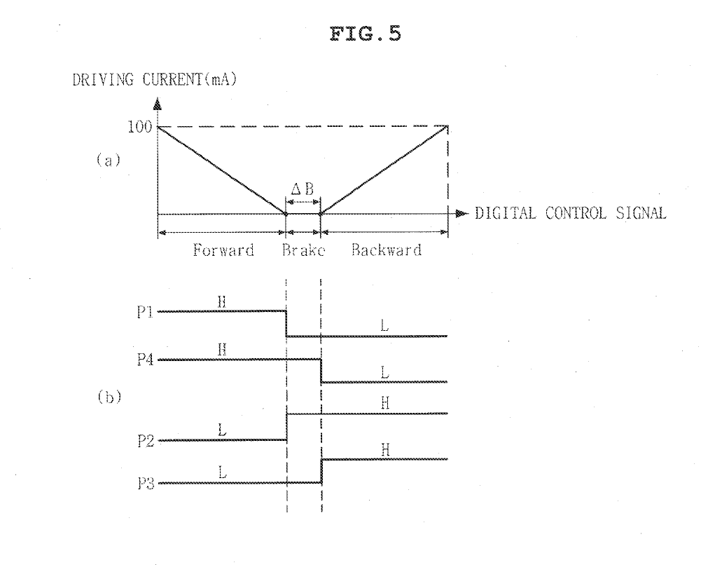

Hereinafter, referring to FIGS. 4 and 5, the process of correcting shaking by the movement of the lens in the system for correcting hand-shake according to an embodiment of the invention will be described in more detail.

FIG. 4 is a circuit diagram showing the configuration of the motor driver according to an embodiment of the invention, and FIGS. 5A and 5B are diagrams illustrating a driving of the motor driver according to an embodiment of the invention.

As illustrated in FIG. 4, the digital signal processor 400 generates the digital control signal (i.e., serial signal) for controlling the driving range of the lens 700 based on the angular velocity component due to the hand-shake and the current positional information of the lens 700, which are detected by the angular velocity sensor (not illustrated) and the hall sensor (not illustrated) and the controller 530 generates the control signals P₁ to P₄ for controlling the first to fourth switches 521 to 524 based on the digital control signal (i.e., serial signal). Herein, 1) P₁ controls the first switch 521, 2) P₂ controls the second switch 522, 3) P₃ controls the third switch 523, and 4) P₄ controls the fourth switch 524.

Further, the signal converter 510 converts the digital control signal (i.e., serial signal) into a current I and then generates the driving voltage V_{D} of the actuator 600 using the current I, in which the driving voltage V_{D} is applied to an N node, which is one terminal of the transistor circuits 525 to 528 through the voltage follower 529 to form a voltage difference from the power supply voltage V_{M}, thereby making the driving current I_{B1} or I_{B2} flow in the actuator (VCM) 600.

Therefore, as illustrated in FIGS. 5A to 5C, 1) when the lens 700 needs to be driven backward due to the photographer's hand-shake, the digital signal processor 400 generates the digital control signal for the moving distance and direction of the lens 700 based on the current positional information of the lens 700, the controller 530 generates the control signal (P₁=LOW, P₂=HIGH, P₃=HIGH, and P₄=LOW) corresponding to the digital control signal and i) turns off the P₁ switch included in the first switch 521 and turns on a P_{1B} switch included therein to turn off the first TR 525, ii) turns on the P₂ switch included in the second switch 522 and turns off a P_{2B} switch included therein to turn on the second TR 525, iii) turns on the P₃ switch included in the third switch 523 and turns off a P_{3B} switch included therein to turn on the third TR 526, and iv) turns off the P₄ switch included in the fourth switch 524 and turns on a P_{4B} switch included therein to turn off the fourth TR 527, depending on the control signal.

Therefore, a driving current I_{B1} due to the voltage difference between the power supply voltage V_{M} and the driving voltage V_{D} flows in the actuator (VCM) 600 and thus the magnetic field strength due to the driving current I_{B1} is changed, such that lens 700 move backward as much as the strength of the driving current I_{B1}. Herein, the digital control signal is configured of 10 bits and at the time of driving the lens 700 backward, the MSB is set to be 1 and the strength of the driving current I_{B1} is determined by 9 bits.

Further, 2) when the lens 700 needs to be driven forward due to the photographer's hand-shake, the digital signal processor 400 generates the digital control signal for the moving distance and direction of the lens 700 based on the current positional information of the lens 700, the controller 530 generates the control signal (P₁=HIGH, P₂=LOW, P₃=LOW, and P₄=HIGH) corresponding to the digital control signal and i) turns on the P₁ switch included in the first switch 521 and turns off the P_{1B} switch included therein to turn on the first TR 525, ii) turns off the P₂ switch included in the second switch 522 and turns on the P_{2B} switch included therein to turn off the second TR 525, iii) turns off the P₃ switch included in the third switch 523 and turns on the P_{3B} a switch included therein to turn off the third TR 526, and iv) turns on the P₄ switch included in the fourth switch 524 and turns off the P_{4B} switch included therein to turn on the fourth TR 527, depending on the control signal. Therefore, the driving current I_{B2} due to the voltage difference between the power supply voltage V_{M} and the driving voltage V_{D} flows in the actuator (VCM).

Therefore, a driving current I_{B2} due to the voltage difference between the power supply voltage V_{M} and the driving voltage V_{D} flows in the actuator (VCM) 600, and thus the magnetic field strength due to the driving current I_{B2} is changed, such that lens 700 moves forward as much as the strength of the driving current I_{B2}. Herein, according to an embodiment, the digital control signal is configured of 10 bits and at the time of driving the lens 700 forward, the MSB is set to be 0 and the strength of the driving current I_{B1} is determined by 9 bits.

Further, 3) since the photographer's hand-shake does not occur and thus the signal detected by the position sensor 100 is not present, when the driving current corresponding to the digital control signal is set to be ‘0’, the controller 530 generates the control signal (P₁=LOW, P₂−HIGH, P₃=LOW, and P₄=HIGH) corresponding to the digital control signal and i) turns off the P₁ switch included in the first switch 521 and turns on the P_{1B} switch included therein to turn off the first TR 525, ii) turns on the P₂ switch included in the second switch 522 and turns off the P_{2B} switch included therein to turn on the second TR 525, iii) turns off the P₃ switch included in the third switch 523 and turns on the P_{3B} switch included therein to turn off the third TR 526, and iv) turns on the P₄ switch included in the fourth switch 524 and turns off the P_{4B} switch included therein to turn on the fourth TR 527, depending on the control signal. Therefore, the driving current I_{B2} or I_{B1} due to the voltage difference between the power supply voltage V_{M} and the driving voltage V_{D} does not flow in the actuator (VCM).

That is, the controller 530 generates the control signal (P₁=LOW, P₂=HIGH, P₃=LOW, and P₄=HIGH) to control the first to fourth switches 521 to 524, so as to prevent the driving current I_{B2} or I_{B1} a from flowing in the actuator (VCM) 600, thereby forming a brake section ΔB in which the lens 700 is not driven, and the brake section ΔB is a section in which the driving direction of the lens 700 is switched and is the intermediate region in the driving range of the lens 700 and the region of 1% to 5% of the entire driving range.

As described above, since the controller generates the driving voltage and the control signal of the actuator using the digital control signal and the switching circuit controls the plurality of transistors supplying the driving current to the actuator so as to correspond to the control signal, even when the driving voltage from the signal converter is not generated, the process of locating the lens at the brake section is performed to more effectively correct the hand-shake, thereby ensuring the accuracy of the hand-shake correcting process.

According to various embodiments of the invention, the system for correcting hand-shake sets the brake section in the intermediate region of the driving range of the lens to be able to more stably perform the image-shake correction due to the photographer's hand-shake based on the positional information detected by the position sensor at the time of driving the lens.

Further, when the position sensor does not detect the hand-shake, and thus the process of correcting image-shake based on the movement of the lens is not required, the lens is located in the preset brake section using the motor driver to prevent the driving current, which is generated when the driving direction of the lens is switched, from overshooting, thereby ensuring the stability and accuracy of the entire system.

In addition, since the controller generates the driving voltage and the control signal of the actuator using the digital control signal and the switching circuit controls the plurality of transistors supplying the driving current to the actuator, so as to correspond to the control signal, even when the driving voltage from the signal converter is not generated, the process of locating the lens at the brake section is performed to more effectively correct the hand-shake, thereby ensuring the accuracy of the hand-shake correcting process.

In the various embodiments of the invention described herein, it will be understood by those skilled in the art that the electronic components described above can be implemented and maintained by electronic hardware, software, or a combination of the two, and that such embodiments are contemplated by embodiments of the present invention.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiments of the present invention may suitably comprise, consist or consist essentially of the elements disclosed and may be practiced in the absence of an element not disclosed. For example, it can be recognized by those skilled in the art that certain steps can be combined into a single step.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

The terms “first,” “second,” “third,” “fourth,” and the like, in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

As used herein, the terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “in one embodiment” herein do not necessarily all refer to the same embodiment.

Ranges may be expressed herein as from about one particular value, and/or to about another particular value. When such a range is expressed, it is to be understood that another embodiment is from the one particular value and/or to the other particular value, along with all combinations within said range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. A system for correcting hand-shake, comprising:
a position sensor configured to detect positional information of a lens;
a digital signal processor configured to generate a digital control signal for controlling a driving range of the lens based on the detected positional information; and
a motor driver configured to generate a driving voltage and a control signal of an actuator for driving the lens based on the digital control signal and controlling the driving of the actuator by a switching operation corresponding to the control signal.

2. The system as set forth in claim 1, wherein the position sensor comprises:
a hall sensor configured to output a signal corresponding to a position of the lens; and
an angular velocity sensor configured to output an angular velocity signal to shaking input from the outside.

3. The system as set forth in claim 1, wherein the driving of the lens comprises a brake section in a predetermined region of the driving range of the lens.

4. The system as set forth in claim 3, wherein the brake section is a section in which a driving direction of the lens is switched and is an intermediate region of the driving range.

5. The system as set forth in claim 4, wherein the brake section is a region of 1% to 5% of the driving range of the lens.

6. The system as set forth in claim 3, wherein the control signal controls a driving of the actuator to correspond to the driving direction before and after the lens or whether the brake driving is performed on one axis of the lens.

7. The system as set forth in claim 6, wherein the actuator is a voice coil motor.

8. The system as set forth in claim 1, wherein the digital signal processor is further configured to generate the control signal by a proportion integral derivative control (PID) control.

9. The system as set forth in claim 1, wherein the motor driver comprises:
a signal converter configured to generate the driving voltage of the actuator corresponding to the digital control signal which is generated by the digital signal processor;
a controller configured to generate the control signal of the actuator for driving the lens based on the digital control signal; and
a driver circuit configured to apply the driving voltage to the actuator by the switching operation based on the control signal.

10. The system as set forth in claim 9, wherein the driving of the lens comprises a brake section in a predetermined region of the driving range of the lens.

11. The system as set forth in claim 10, wherein the brake section is a section in which a driving direction of the lens is switched and is an intermediate region of the driving range.

12. The system as set forth in claim 11, wherein the brake section is a region of 1% to 5% of the driving range of the lens.

13. The system as set forth in claim 12, wherein the control signal controls the driving direction of the lens or whether the brake driving is performed on one axis of the lens.

14. The system as set forth in claim 9, wherein the actuator is a voice coil motor.

15. The system as set forth in claim 13, wherein the driver circuit comprises:
a transistor circuit configured to control a driving current of the actuator based on the driving voltage; and
a switching circuit configured to control a driving of the transistor circuit through the switching operation depending on the control signal.

16. The system as set forth in claim 15, wherein the driver circuit further comprises:
a voltage follower configured to transfer the driving voltage input from the signal converter to one terminal of the transistor circuit.

17. The system as set forth in claim 16, wherein the transistor is a metal oxide semiconductor (MOS) transistor.

18. A method for correcting hand-shake, comprising:
detecting, by a position sensor, positional information of a lens;
generating, by a digital signal processor, a digital control signal for controlling a driving range of the lens based on the detected positional information; and
generating, by a motor driver, a driving voltage and a control signal of an actuator for driving the lens based on the digital control signal and controlling the driving of the actuator by a switching operation corresponding to the control signal.

19. The method as set forth in claim 18, wherein the controlling of the driving of the actuator comprises:
generating, by a signal converter, a driving voltage of the actuator corresponding to the digital control signal;
generating, by a controller, the control signal of the actuator for driving the lens based on the digital control signal; and
applying, by a driver circuit, the driving voltage to the actuator by the switching operation based on the control signal.

20. The method as set forth in claim 19, wherein the applying of the driving voltage to the actuator comprises:
controlling, by a transistor circuit, a driving current of the actuator based on the driving voltage; and
controlling, by a switching circuit, a driving of the transistor circuit through the switching operation depending on the control signal.

21. The method as set forth in claim 20, further comprising:
transferring, by a voltage follower, the driving voltage input from the signal converter to one terminal of the transistor circuit.

22. The method as set forth in claim 21, wherein the control signal controls a driving of the actuator to correspond to the driving direction of the lens or whether the brake driving is performed on one axis of the lens.
